(19) United States
(12) Patent Application Publication
(10) Pub. No.: US 2018/0257788 A1
(43) Pub. Date: Sep. 13, 2018

(54) AIR INTAKE ASSEMBLY WITH HORIZONTAL DOOR FOR AN AIRCRAFT AUXILIARY POWER UNIT

(71) Applicant: United Technologies Corporation, Farmington, CT (US)

(72) Inventor: Xuejun Liu, Avon, CT (US)

(21) Appl. No.: 15/454,695

(22) Filed: Mar. 9, 2017

(51) Int. Cl. B64D 33/02; B64D 41/00; B64C 5/02; F02C 3/04

(52) U.S. Cl. CPC B64D 33/02; B64D 41/00; F05D 2220/32; F02C 3/04; B64D 2033/0213; B64C 5/02

(57) ABSTRACT

An aircraft system includes an aircraft fuselage, an auxiliary power unit and an air inlet assembly. The auxiliary power unit is within the aircraft fuselage. The auxiliary power unit may be configured as or otherwise include an engine. The air inlet assembly includes an inlet orifice, an inlet duct and a door. The inlet duct fluidly couples the inlet orifice with an airflow inlet of the engine. The door is configured to pivot about a generally horizontal pivot axis between an open position and a closed position. The door opens the inlet orifice in the open position and substantially closes the inlet orifice in the closed position.

### BACKGROUND OF THE INVENTION

### 1. Technical Field

This disclosure relates generally to an aircraft system and, more particularly, to an air intake assembly for an auxiliary power unit.

### 2. Background Information

A typical auxiliary power unit for an aircraft receives air for combustion through an air intake assembly. This assembly may include a door on the outside of the airplane fuselage for opening and closing an inlet orifice. When the door is closed, air outside of the airplane fuselage cannot flow into the inlet orifice and to the auxiliary power unit. By contrast, when the door is open, air outside of the airplane fuselage may flow into the inlet orifice and to the auxiliary power unit.

A typical air intake assembly door pivots about a generally vertical pivot axis to open and close the inlet orifice. This enables the door to function as a ram scoop when the auxiliary power unit must be operated during flight. However, such an arrangement leaves the inlet orifice susceptible to ice accumulation for ground operation. For example, when the airplane is at an airport gate, rain, snow, etc. may fall directly into the inlet orifice and freeze to the air intake assembly. This accumulation of ice reduces airflow to the engine. In addition, chunks of accumulated ice may break off and enter the auxiliary power unit. The ice can cause mechanical damage to the compressor blades.

There is a need in the art for an improved air inlet assembly for an auxiliary power unit.

### SUMMARY OF THE DISCLOSURE

According to an aspect of the present disclosure, an aircraft system is provided that includes an aircraft fuselage, an auxiliary power unit and an air inlet assembly. The auxiliary power unit is within the aircraft fuselage. The auxiliary power unit is configured as or otherwise includes an engine. The air inlet assembly includes an inlet orifice, an inlet duct and a door. The inlet duct fluidly couples the inlet orifice with an airflow inlet of the engine. The door is configured to pivot about a generally horizontal pivot axis between an open position and a closed position. The door opens the inlet orifice in the open position and substantially closes the inlet orifice in the closed position.

According to another aspect of the present disclosure, another aircraft system is provided that includes an aircraft fuselage, an auxiliary power unit and an air inlet assembly. The aircraft fuselage extends along a longitudinal axis. The auxiliary power unit is within the aircraft fuselage. The air inlet assembly includes an inlet orifice, an inlet duct and a door. The inlet duct fluidly couples the inlet orifice with an airflow inlet of the auxiliary power unit. The door is configured to pivot about a pivot axis between an open position and a closed position. The pivot axis is generally parallel with the longitudinal axis. The door opens the inlet orifice in the open position and substantially closes the inlet orifice in the closed position.

According to still another aspect of the present disclosure, another aircraft system is provided that includes an aircraft fuselage, an auxiliary power unit and an air inlet assembly. The auxiliary power unit is within the aircraft fuselage. The air inlet assembly includes an inlet orifice, an inlet duct and a door. The inlet duct fluidly couples the inlet orifice with the auxiliary power unit. The door is configured to pivot about a pivot axis between an open position and a closed position. The door opens the inlet orifice in the open position and substantially closes the inlet orifice in the closed position. There is no straight line of sight into the inlet orifice from directly vertically above the inlet orifice when the door is in the open position.

The pivot axis may be substantially parallel with a gravitational horizontal horizon line. Alternatively, the pivot axis may be angularly offset from the gravitational horizontal horizon line by no more than five or ten degrees.

The door may extend vertically between a bottom end and a top end when the door is closed. The pivot axis may be at the top end.

The door may extend vertically between a bottom end and a top end when the door is closed. The air inlet assembly may include a hinge connected to the door at the top end.

The door may be generally horizontal in the open position.

A vertical stabilizer wing may be included and project vertically out from the aircraft fuselage. The air inlet assembly may be located aft of the vertical stabilizer wing.

There may be no straight line of sight into the inlet orifice from directly vertically above the inlet orifice when the door is in the open position.

The engine may include a compressor section, a turbine section and a combustor section between the compressor section and the turbine section.

The pivot axis may be a generally horizontal pivot axis.

The pivot axis may be substantially parallel with the longitudinal axis.

The pivot axis may be angularly offset from the longitudinal axis by no more than five or ten degrees.

The aircraft fuselage may extend along a longitudinal axis. The pivot axis may be generally parallel with the longitudinal axis.

The door may be configured to pivot about the generally horizontal pivot axis between the open position and the closed position during a first mode (e.g., during on ground operation). The door may be further configured to pivot about a second pivot axis between another open position and the closed position during a second mode (e.g., during in flight operation). The second pivot axis may be angularly offset from the generally horizontal pivot axis.

The foregoing features and the operation of the invention will become more apparent in light of the following description and the accompanying drawings.

### BRIEF DESCRIPTION OF THE DRAWINGS

FIG. 1 is a perspective diagrammatic illustration on an aircraft system for an aircraft.

FIG. 2 is a schematic illustration of a tail end portion of the aircraft system.

FIG. 3 is a schematic illustration of an auxiliary power unit (APU) configured as a gas turbine engine.

FIG. 4 is a perspective diagrammatic illustration of a tail end portion of the aircraft system.

FIG. 5 is a side schematic illustration of an air intake assembly for the auxiliary power unit with a door of the air intake assembly in a partially open position.

FIG. 6 is a partial sectional schematic illustration of the air intake assembly for the auxiliary power unit with the door in a closed position.

FIG. 7 is a partial sectional schematic illustration of the air intake assembly for the auxiliary power unit with the door in an open position.

FIG. 8 is a side schematic illustration of another air intake assembly for the auxiliary power unit with a door of the air intake assembly in a closed position.

FIGS. 9-11 are side sectional schematic illustrations of the door, where the door is configured to open to different maximum open positions.

FIG. 12 is an illustration of how an aircraft fuselage interacts with super-cooled water particles during flight.

FIG. 13 is a side schematic illustration of the air intake assembly for the auxiliary power unit with the door of the air intake assembly in another partially open position.

### DETAILED DESCRIPTION OF THE INVENTION

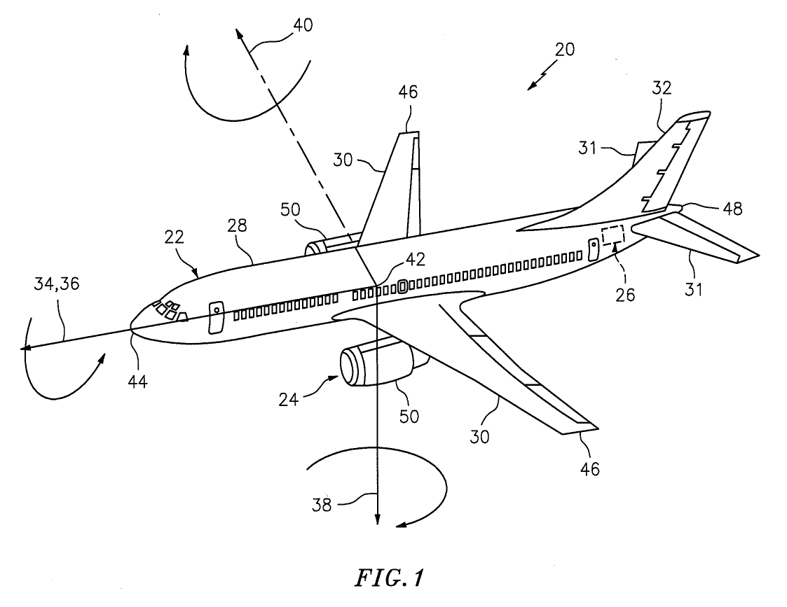

FIG. 1 illustrates an aircraft system 20 for an aircraft, for example an airplane such as a commercial airliner or a cargo plane. The aircraft system 20 includes an airframe 22, a propulsion system 24 and an auxiliary power system 26, which is shown in block diagram form.

The airframe 22 includes a fuselage 28 and a plurality of wings 30-32. The fuselage 28 forms a central body of the aircraft and has a horizontal longitudinal axis 34. Herein, the term “horizontal” is used to describe a gravitational orientation of an element (e.g., the longitudinal axis 34) when the aircraft is on ground and/or in level flight. The longitudinal axis 34 may be coaxial with a roll axis 36 of the aircraft.

Briefly, the aircraft includes a yaw axis 38, a pitch axis 40 and the roll axis 36. These axes 36, 38 and 40 are coincident at an origin 42, which may correspond to a center of gravity of the aircraft. The yaw axis 38 is perpendicular to a plane of the wings 30. The yaw axis 38 extends from the origin 42 in a direction towards a bottom of the aircraft; e.g., downwards. Yaw axis motion thereby results in side-to-side movement of a nose 44 of the aircraft. The pitch axis 40 is perpendicular to the yaw axis 38 and parallel to the plane of the wings 30. The pitch axis 40 extends from the origin 42 in a direction towards a tip 46 of one of the wings 30. Pitch axis motion thereby results in up and down movement of the aircraft nose 44. The roll axis 36 is perpendicular to the yaw axis 38 and the pitch axis 40. The roll axis 36 extends from the origin 42 in a direction towards the aircraft nose 44. Roll axis motion thereby results in up and down movement of the wing tips 46.

The plurality of wings 30-32 include one or more main or general lift wings 30, one or more horizontal stabilizer wings 31 and at least one vertical stabilizer wing 32. The main wings 30 are disposed on and connected to opposing sides of the fuselage 28. The horizontal stabilizer wings 31 are disposed on and connected to the opposing sides of the fuselage 28 at (e.g., on, adjacent or proximate) an aft, tail end 48 of the fuselage 28. The vertical stabilizer wing 32 projects vertically out from and is connected to the fuselage 28 at the tail end 48. Herein, the term “vertical” is used to describe a gravitational orientation of an element (e.g., the stabilizer wing 32) when the aircraft is on ground and/or in level flight. The vertical stabilizer wing 32 is generally aligned with the horizontal stabilizer wings 31 along the longitudinal axis 34.

The propulsion system 24 includes one or more gas turbine engines 50, each housed within a nacelle. Each of these gas turbine engines 50 may be mounted to a respective one of the main wings 30 by pylon structure. Each of the gas turbine engines 50 may be configured as a turbofan engine as shown in FIG. 1. Alternatively, each gas turbine engine 50 may be configured as a turbojet engine, a propfan engine, a pusher fan engine or any other type of gas turbine engine capable of propelling the aircraft.

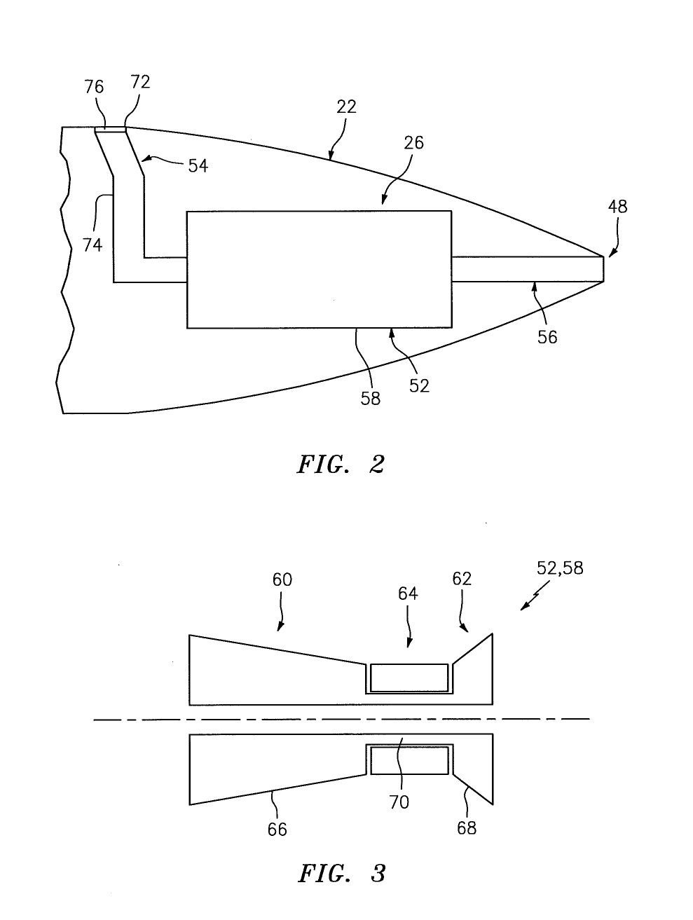

Referring to FIG. 2, the auxiliary power system 26 is configured to provide pneumatic, hydraulic and/or electrical power to the aircraft during propulsion system 24 startup, inflight emergency (e.g., loss of pneumatic, hydraulic and/or electrical power from the propulsion system 24), etc. However, during normal aircraft flight, the auxiliary power system 26 may be placed on standby or turned off.

The auxiliary power system 26 includes an auxiliary power unit 52, an air inlet assembly 54 and an exhaust 56. The auxiliary power unit 52 may be configured as or otherwise include a gas turbine engine 58. The auxiliary power unit 52 of FIG. 3, for example, is configured as a single spool/single shaft gas turbine engine. This auxiliary power unit 52 includes a compressor section 60, a turbine section 62 and a combustor section 64, which is located axially between and fluidly coupled with the compressor section 60 and the turbine section 62. One or more compressor rotors 66 in the compressor section 60 are connected to and driven by one or more turbine rotors 68 in the turbine section 62 through a shaft 70. The present disclosure, however, is not limited to the foregoing exemplary auxiliary power unit configuration. For example, in other embodiments, the auxiliary power unit 52 may include a gas turbine engine with two or more spools. In still other embodiments, the auxiliary power unit 52 may be configured as or otherwise include another (non-gas turbine) type of engine; e.g., a piston or rotary internal combustion engine.

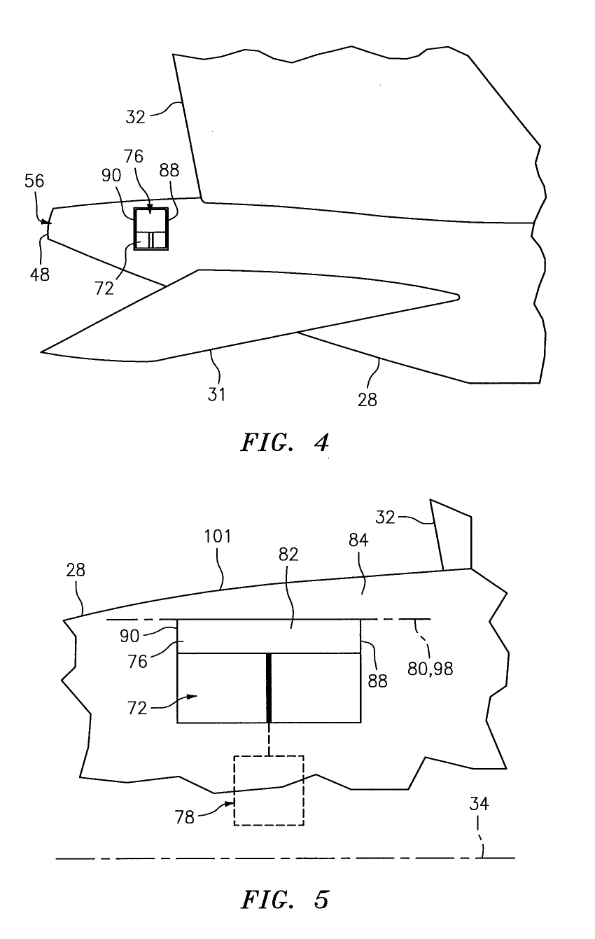

Referring again to FIG. 2, the air inlet assembly 54 includes an inlet orifice 72, an inlet duct 74 and a door 76. Referring now to FIG. 4, the inlet orifice 72 extends through an exterior skin (e.g., wall) of the fuselage 28 at the tail end 48. The inlet orifice 72 may be located on the side of the fuselage 28, aft of the vertical stabilizer wing 32 and/or aft of the horizontal stabilizer wings 31. The inlet orifice 72 may have a polygonal (e.g., rectangular) cross-sectional shape, or any other cross-sectional shape.

Referring to FIG. 2, the inlet duct 74 fluidly couples the inlet orifice 72 with an airflow inlet of the auxiliary power unit 52 and its engine 58.

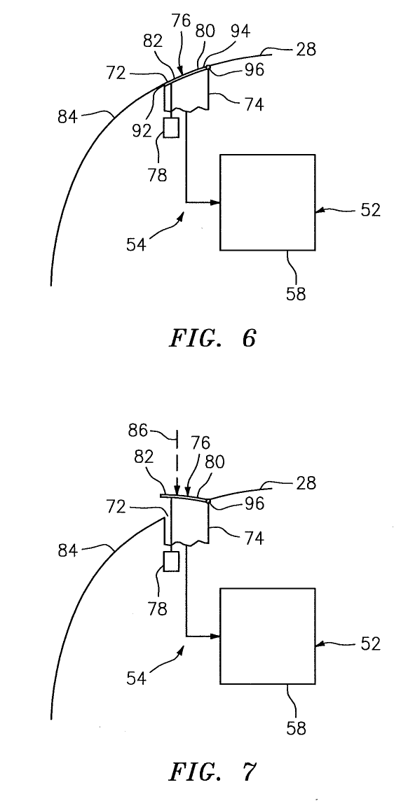

Referring to FIGS. 5-7, an actuator 78 (e.g., a hydraulic piston, a lead screw device, etc.) is configured to pivot the door 76 about a generally horizontal pivot axis 80 between a closed position (see FIG. 6) and an open position (see FIG. 7). When the door 76 is in the closed position (see FIG. 6), the door 76 is configured to substantially close the inlet orifice 72 such that little or no air enters the air inlet assembly 54 from outside of the fuselage 28. An exterior (e.g., planar or curved) surface 82 of the door 76 also aligns with an exterior surface 84 of the surrounding exterior skin of the fuselage 28 to reduce flow disturbances. The surface 82, for example, may be substantially flush with, or recessed into the fuselage 28 from, the surface 84.

When the door 76 is in the open position (see FIG. 7), the door 76 is configured to pivoted away from the inlet orifice 72 such that air from outside the fuselage 28 may travel through the air inlet assembly 54 to the auxiliary power unit 52. However, the door 76 is also configured to cover the inlet orifice 72 to reduce or prevent particles (e.g., rain water droplets, snow, etc.) from entering the air inlet assembly 54. In particular, the open door 76 is configured relative to the inlet orifice 72 such that there is no straight line of sight into the inlet orifice 72 from directly vertically above the inlet orifice 72; e.g., see blocked line of sight 86. As a result, the door 76 is operable to reduce or prevent formation of ice buildup at the inlet orifice 72 and/or within the inlet duct 74.

The door 76 has a cross-sectional shape that is approximately the same as the cross-sectional shape of the inlet orifice 72. The door 76 extends longitudinally along the longitudinal axis 34 of the fuselage 28 between an upstream, forward end 88 and a downstream, aft end 90; see FIG. 5. The door 76 also extends vertically (when the door 76 is closed) between a bottom end 92 and a top end 94; see FIG. 6.

At least one hinge 96 may be connected to the door 76 at (e.g., on, adjacent or proximate) the top end 94, where that hinge 96 pivotally connects the door 76 to the fuselage 28 and/or a mounting portion of the air inlet assembly 54. The hinge 96 is configured such that the pivot axis 80 is substantially parallel with a gravitational horizontal horizon line 98 (see FIG. 5); e.g., substantially horizontal relative to gravity. However, in other embodiments, the pivot axis 80 may be angularly offset from the gravitational horizontal horizon line 98 by five or ten degrees as shown in FIG. 8 to align with the top ridge line of the fuselage 28.

With the foregoing configuration, the pivot axis 80 may be generally parallel with the longitudinal axis 34. For example, the pivot axis 80 may be substantially parallel with the longitudinal axis 34 (see FIG. 5). Alternatively, the pivot axis 80 may be angularly offset from the longitudinal axis 34 by five or ten degrees (see FIG. 8).

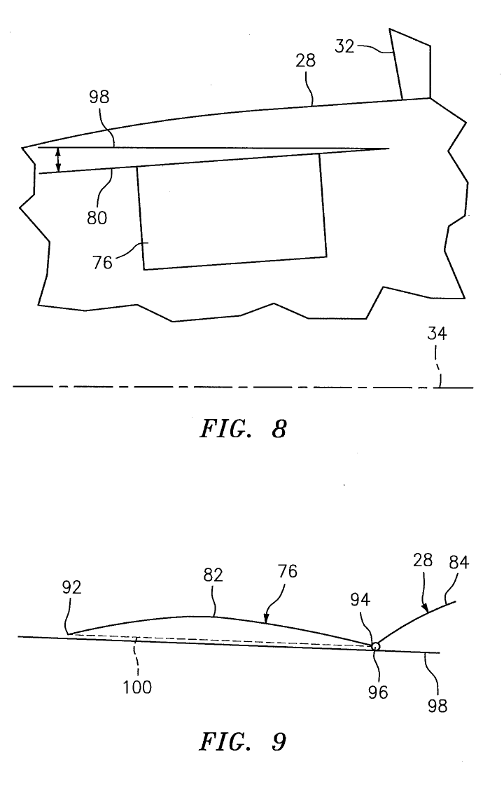

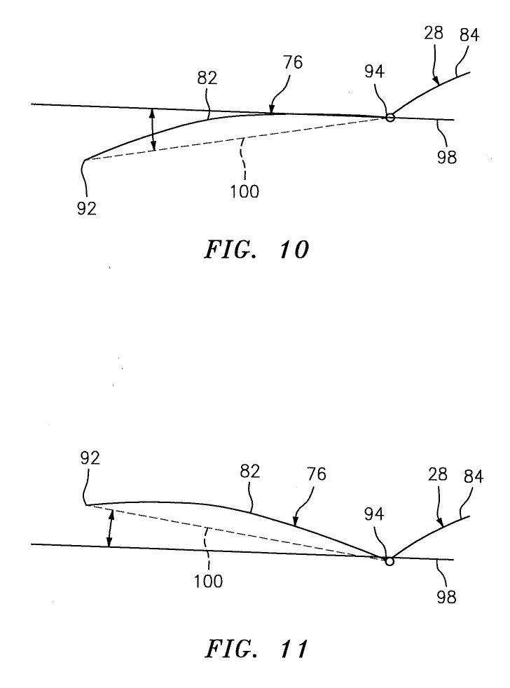

In some embodiments, referring to FIG. 9, the exterior surface 82 of the door 76 may be substantially horizontal when the door 76 is in the open position. For example, a top end to bottom end chord line 100 of the door 76 (where the exterior surface 82 is arcuate) may be substantially horizontal and parallel with the gravitational horizontal horizon line 98. In other embodiments, referring to FIG. 10, the bottom end 92 of the door 76 may be vertically below the top end 94 when the door 76 is in the open position. Thus, the exterior surface 82 may be sloped downward away from the fuselage 28; e.g., minus 5-10 degrees from horizontal. In still other embodiments, referring to FIG. 11, the bottom end 92 of the door 76 may be vertically above the top end 94 when the door 76 is in the open position. Thus, the exterior surface 82 may be sloped downward towards from the fuselage 28; e.g., plus 5-10 degrees from horizontal. In addition to covering the inlet orifice 72, the foregoing embodiments also facilitate removal of ice accumulation from the exterior surface 82 of the open door 76 using traditional de-icing techniques.

In some embodiments, referring to FIG. 5, the pivot axis 80 may be generally (e.g., slightly offset (e.g., 5-10 degrees) from or substantially) aligned with the top ridge line 101 of the fuselage 28, aft of the vertical stabilizer wing 32. The door 76 may be located on a left side or a right side fuselage 28 aft looking forward. The exterior surface 82 may be angled plus or minus 5-10 degrees about the longitudinal axis 34, and the exterior surface 82 may be angled 5-10 degrees about pitch axis 40 to have the same pitch angle with the top ridge line 101 of fuselage 28. The slanted exterior surface 82 also may utilize gravity to help in removal of ice accretion from the exterior surface 82 of the open door 76 using traditional de-icing techniques.

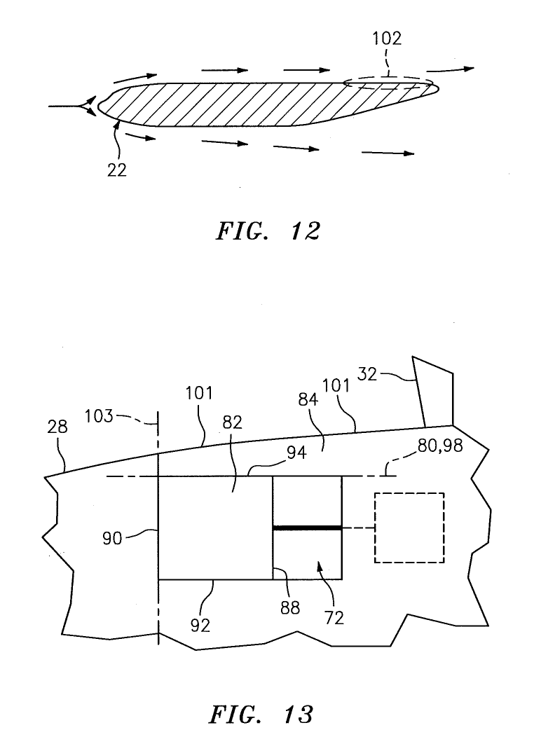

During certain conditions such as an engine flameout, loss of propulsion system 24 power, etc., the auxiliary power unit 52 may be operated during aircraft flight. The placement of the air inlet assembly 54 at the tail end 48 of the fuselage 28 may dispose the inlet orifice 72 within shadow zone 102 of the aircraft as shown in FIG. 12. As a result, most particles (e.g., rain water droplets, snow, etc.) in the air may flow around the inlet orifice 72 without entering the air inlet assembly 54.

In some embodiments, referring to FIG. 13, the door 76 can be configured to open to the front. For example, at least one additional hinge may be connected to the door 76 at the aft end 90, where that additional hinge pivotally connects the door 76 to the fuselage 28 and/or the mounting portion of the air inlet assembly 54. This additional hinge may be configured to pivot about another pivot axis 103 which is angularly offset from the pivot axis 80; e.g., substantially perpendicular to the pivot axis 80. With such a configuration, the door 76 may open during at least a first mode (e.g., when the aircraft is in flight) to the front using the additional hinge to provide a ram air effect for the inlet assembly 54. However, during at least another operating mode (e.g., when the aircraft is on the ground), the door 76 may open towards the side (e.g., see FIGS. 5 and 7) using the hinge 96 as described above.

While various embodiments of the present invention have been disclosed, it will be apparent to those of ordinary skill in the art that many more embodiments and implementations are possible within the scope of the invention. For example, the present invention as described herein includes several aspects and embodiments that include particular features. Although these features may be described individually, it is within the scope of the present invention that some or all of these features may be combined with any one of the aspects and remain within the scope of the invention. Accordingly, the present invention is not to be restricted except in light of the attached claims and their equivalents.

What is claimed is:

1. An aircraft system, comprising:
an aircraft fuselage;
an auxiliary power unit within the aircraft fuselage, and comprising an engine; and
an air inlet assembly including an inlet orifice, an inlet duct and a door, the inlet duct fluidly coupling the inlet orifice with an airflow inlet of the engine, and the door configured to pivot about a generally horizontal pivot axis between an open position and a closed position, wherein the door opens the inlet orifice in the open position and substantially closes the inlet orifice in the closed position.

2. The aircraft system of claim 1, wherein the pivot axis is substantially parallel with a gravitational horizontal horizon line.

3. The aircraft system of claim 1, wherein the pivot axis is angularly offset from a gravitational horizontal horizon line by no more than ten degrees.

4. The aircraft system of claim 1, wherein the pivot axis is angularly offset from a gravitational horizontal horizon line by no more than five degrees.

5. The aircraft system of claim 1, wherein the aircraft fuselage has a horizontal longitudinal axis, and the pivot axis is generally parallel with the horizontal longitudinal axis.

6. The aircraft system of claim 1, wherein the door extends vertically between a bottom end and a top end when the door is closed, and the pivot axis is at the top end.

7. The aircraft system of claim 1, wherein the door extends vertically between a bottom end and a top end when the door is closed, and the air inlet assembly further includes a hinge connected to the door at the top end.

8. The aircraft system of claim 1, wherein the door is generally horizontal in the open position.

9. The aircraft system of claim 1, further comprising:
a vertical stabilizer wing projecting vertically out from the aircraft fuselage;
wherein the air inlet assembly is located aft of the vertical stabilizer wing.

10. The aircraft system of claim 1, wherein there is no straight line of sight into the inlet orifice from directly vertically above the inlet orifice when the door is in the open position.

11. The aircraft system of claim 1, wherein the engine comprises a compressor section, a turbine section and a combustor section between the compressor section and the turbine section.

12. The aircraft system of claim 1, wherein
the door is configured to pivot about the generally horizontal pivot axis between the open position and the closed position during a first mode;
the door is further configured to pivot about a second pivot axis between another open position and the closed position during a second mode; and
the second pivot axis is angularly offset from the generally horizontal pivot axis.

13. An aircraft system, comprising:
an aircraft fuselage extending along a longitudinal axis;
an auxiliary power unit within the aircraft fuselage; and
an air inlet assembly including an inlet orifice, an inlet duct and a door, the inlet duct fluidly coupling the inlet orifice with an airflow inlet of the auxiliary power unit, and the door configured to pivot about a pivot axis between an open position and a closed position, wherein the pivot axis is generally parallel with the longitudinal axis, and wherein the door opens the inlet orifice in the open position and substantially closes the inlet orifice in the closed position.

14. The aircraft system of claim 13, wherein the pivot axis is a generally horizontal pivot axis.

15. The aircraft system of claim 13, wherein the pivot axis is substantially parallel with the longitudinal axis.

16. The aircraft system of claim 13, wherein the pivot axis is angularly offset from the longitudinal axis by no more than ten degrees.

17. The aircraft system of claim 13, wherein the door extends vertically between a bottom end and a top end when the door is closed, and the air inlet assembly further includes a hinge connected to the door at the top end.

18. An aircraft system, comprising:
an aircraft fuselage;
an auxiliary power unit within the aircraft fuselage; and
an air inlet assembly including an inlet orifice, an inlet duct and a door, the inlet duct fluidly coupling the inlet orifice with the auxiliary power unit, and the door configured to pivot about a pivot axis between an open position and a closed position;
wherein the door opens the inlet orifice in the open position and substantially closes the inlet orifice in the closed position; and
wherein there is no straight line of sight into the inlet orifice from directly vertically above the inlet orifice when the door is in the open position.

19. The aircraft system of claim 18, wherein the door extends vertically between a bottom end and a top end when the door is closed, and the air inlet assembly further includes a hinge connected to the door at the top end.

20. The aircraft system of claim 18, wherein the pivot axis is a generally horizontal pivot axis.
